(19) United States
(12) Patent Application Publication
(10) Pub. No.: US 2024/0406022 A1
(43) Pub. Date: Dec. 5, 2024

(54) METHOD AND DEVICE FOR SUPPORTING COMMUNICATION OF PLURALITY OF GROUPS HAVING DIFFERENT QUALITY OF SERVICE REQUIREMENTS IN WIRELESS COMMUNICATION SYSTEM

(71) Applicant: SAMSUNG ELECTRONICS CO., LTD., Suwon-si, Gyeonggi-do (KR)

(72) Inventor: Sangjun MOON, Suwon-si (KR)

(21) Appl. No.: 18/699,575

(22) PCT Filed: Oct. 7, 2022
(86) PCT No.: PCT/KR2022/015150

§ 371 Date: Apr. 8, 2024

(30) Foreign Application Priority Data
Oct. 8, 2021 (KR) 10-2021-0134482

(51) Int. Cl. H04L 12/18; H04L 47/2475; H04L 61/5069

(52) U.S. Cl. CPC H04L 12/1886; H04L 12/185; H04L 47/2475; H04L 61/5069

(57) ABSTRACT

The present disclosure relates to: a communication technique merging IoT technology with a 5G communication system for supporting a data transmission rate higher than that of a 4G system; and a system therefor. The present disclosure provides a method by which a terminal supports communication of a plurality of groups having different QoSs in a wireless communication system. The method may comprise the steps of: receiving, from at least one application client having a predetermined address value, traffic directed toward an application server; setting a first group associated with the predetermined address value; establishing a PDU session for one from among the first group associated with the predetermined address value and a second group associated with the application server set by means of an AF; and transmitting the traffic to the application server through the generated PDU session.

### TECHNICAL FIELD

This disclosure relates to a method and device for supporting multiple group communications with different QoS requirements in 5GS.

### BACKGROUND ART

In order to meet the demand for wireless data traffic soring since the 4G communication system came to the market, there are ongoing efforts to develop enhanced 5G communication systems or pre-5G communication systems. For the reasons, the 5G communication system or pre-5G communication system is called the beyond 4G network communication system or post LTE system. For higher data transmit rates, 5G communication systems are considered to be implemented on ultra-high frequency bands (mmWave), such as, e.g., 60 GHz. To mitigate pathloss on the ultra-high frequency band and increase the reach of radio waves, the following techniques are taken into account for the 5G communication system: beamforming, massive multi-input multi-output (MIMO), full dimensional MIMO (FD-MIMO), array antenna, analog beamforming, and large scale antenna. Also being developed are various technologies for the 5G communication system to have an enhanced network, such as evolved or advanced small cell, cloud radio access network (cloud RAN), ultra-dense network, device-to-device (D2D) communication, wireless backhaul, moving network, cooperative communication, coordinated multi-point (CoMP), and interference cancellation. There are also other various schemes under development for the 5G system including, e.g., hybrid FSK and QAM modulation (FQAM) and sliding window superposition coding (SWSC), which are advanced coding modulation (ACM) schemes, and filter bank multi-carrier (FBMC), non-orthogonal multiple access (NOMA) and sparse code multiple access (SCMA), which are advanced access schemes.

The Internet is evolving from the human-centered connection network by which humans create and consume information to the Internet of Things (IoT) network by which information is communicated and processed between things or other distributed components. Another arising technology is the Internet of Everything (IoE), which is a combination of the Big data processing technology and the IoT technology through, e.g., a connection with a cloud server. To implement the IoT, technology elements, such as a sensing technology, wired/wireless communication and network infra, service interface technology, and a security technology, are required. There is a recent ongoing research for inter-object connection technologies, such as the sensor network, Machine-to-Machine (M2M), or the Machine-Type Communication (MTC). In the IoT environment may be offered intelligent Internet Technology (IT) services that collect and analyze the data generated by the things connected with one another to create human life a new value. The IoT may have various applications, such as the smart home, smart building, smart city, smart car or connected car, smart grid, health-care, or smart appliance industry, or state-of-art medical services, through conversion or integration of existing information technology (IT) techniques and various industries.

Thus, there are various ongoing efforts to apply the 5G communication system to the IoT network. For example, the sensor network, machine-to-machine (M2M), machine type communication (MTC), or other 5G techniques are implemented by schemes, such as beamforming, multi-input multi-output (MIMO), and array antenna schemes. The above-mentioned application of the cloud radio access network (RAN) as a Big data processing technique may be said to be an example of the convergence of the 5G and IoT technologies.

### DETAILED DESCRIPTION OF THE INVENTION

### Technical Problem

It is required to support a method of communication using group communications with different QoS requirements when a 3GPP network (5GS) is used in a smart energy infrastructure to transfer several applications through one UE. In this case, a plurality of groups in one UE need to be simultaneously supported. Each group needs to meet different QoS requirements, and each application is positioned in a separate application having IP or Ethernet in the 5GS UE. Since the content of each application is encrypted for security purposes, it is impossible for the 5GS UE to identify and classify application traffic content.

### Technical Solution

The disclosure provides a method by a user equipment (UE) supporting a plurality of group communications having different qualities of service (QoSs) in a wireless communication system. The method may comprise receiving traffic from at least one application client having a predetermined address value to an application server, setting a first group associated with the predetermined address value, establishing a PDU session for one of the first group associated with the predetermined address value and a second group associated with the application server set by an application function (AF), and transmitting the traffic to the application server through the generated PDU session.

The disclosure provides a UE supporting a plurality of group communications having different qualities of service (Qos) in a wireless communication system. The UE may comprise a transceiver and a controller configured to control the transceiver to receive traffic from at least one application client having a predetermined address value to an application server, set a first group associated with the predetermined address value, establish a PDU session for one of the first group associated with the predetermined address value and a second group associated with the application server set by an application function (AF), and control the transceiver to transmit the traffic to the application server through the generated PDU session.

### Advantageous Effects

According to an embodiment of the disclosure, it is possible to simultaneously support a plurality of group communications having different QoS requirements in 5GS.

### BRIEF DESCRIPTION OF DRAWINGS

FIG. 1 is a view illustrating a smart energy infrastructure using 5GS according to an embodiment of the disclosure;

FIG. 2 is a view illustrating a conventional group communication scheme using 5GS;

FIG. 3 is a view illustrating dynamic QoS/group mapping according to an embodiment of the disclosure;

FIG. 4 is a view illustrating preset QoS/group mapping according to an embodiment of the disclosure;

FIG. 5 is a view illustrating a 5GS structure for group configuration according to various embodiments of the disclosure:

FIG. 6 is a view illustrating a method for performing dynamic QoS/group mapping based on an Ethernet address according to an embodiment of the disclosure;

FIGS. 7A and 7B are views illustrating a method for performing dynamic QoS/group mapping based on an Ethernet address using a PDU session reject procedure according to an embodiment of the disclosure;

FIGS. 8A and 8B are views illustrating a method for performing dynamic QoS/group mapping based on an Ethernet address using a PDU session change procedure according to an embodiment of the disclosure;

FIG. 9 is a view illustrating a method for performing dynamic QoS/group mapping based on an IP address according to an embodiment of the disclosure;

FIGS. 10A and 10B are views illustrating a method for performing dynamic QoS/group mapping based on an IP address using a PDU session reject procedure according to an embodiment of the disclosure:

FIGS. 11A and 11B are views illustrating a method for performing dynamic QoS/group mapping based on an IP address using a PDU session change procedure according to an embodiment of the disclosure;

FIG. 12 is a view illustrating a method for performing preset QoS/group mapping based on an Ethernet address according to an embodiment of the disclosure;

FIG. 13 is a view illustrating a method for performing preset QoS/group mapping based on a port number mapped to an Ethernet address according to an embodiment of the disclosure;

FIG. 14 is a view illustrating a method for performing preset QoS/group mapping based on an IP address according to an embodiment of the disclosure;

FIG. 15 is a view illustrating a method for performing preset QoS/group mapping based on a port number mapped to an IP address according to an embodiment of the disclosure; and

FIG. 16 is a view illustrating a structure of a network entity (ies) according to an embodiment of the disclosure.

### MODE FOR CARRYING OUT THE INVENTION

Hereinafter, the operational principle of the disclosure is described below with reference to the accompanying drawings. When determined to make the subject matter of the present disclosure unclear, the detailed of the known functions or configurations may be skipped. The terms as used herein are defined considering the functions in the present disclosure and may be replaced with other terms according to the intention or practice of the user or operator. Therefore, the terms should be defined based on the overall disclosure.

As used herein, terms for identifying access nodes, terms denoting network entities, terms denoting messages, terms denoting inter-network entity interfaces, and terms denoting various pieces of identification information are provided as an example for ease of description. Thus, the disclosure is not limited by the terms, and such terms may be replaced with other terms denoting objects with equivalent technical concept.

For ease of description, the terms and names defined in the latest 3rd generation partnership project 5G and NR standards among the current communication standards are used herein. However, the disclosure is not limited by such terms and names and may be likewise applicable to wireless communication networks conforming to other standards. In particular, the disclosure may be applied to 3GPP GS/NR (5th generation mobile communication standards).

In an infrastructure for smart energy, various applications distributed in several regions may transmit state/event information to a central server, and the central server may transmit all/per-group/individual configuration information or adjustment information to the various applications.

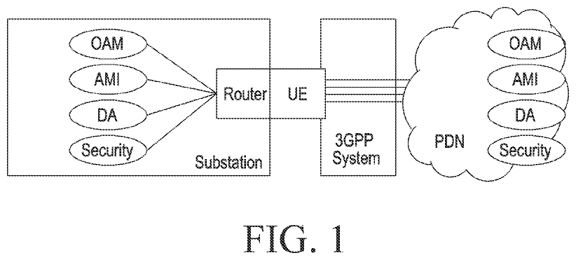

FIG. 1 is a view illustrating a smart energy infrastructure using 5GS according to an embodiment of the disclosure.

Referring to FIG. 1, when an infrastructure structure for smart energy is obtained by using a 5G system (5GS), a substation distributed in each regions may support applications. In this case, each application may have different QoS requirements. For example, operation administration maintenance (OAM) should be able to guarantee a latency of about 10 seconds at a data rate of 100 kbps. Further, the advanced meter infrastructure (AMI) should be able to guarantee a latency of about 2 seconds at a data rate of 100 kbps or less. Further, the distribution automation (DA) should guarantee a latency of 100 ms at a data rate of 100 kbps or less. Further, security (surveillance video) should be able to support a latency of 10 seconds or less at a data rate of 500 kbps. Applications may be transmitted with individual QoS requirements to the individual groups.

In an infrastructure for smart energy, various applications distributed in several regions may transmit state/event information to a central server, and the central server may transmit all/per-group/individual configuration information or adjustment information to the various applications.

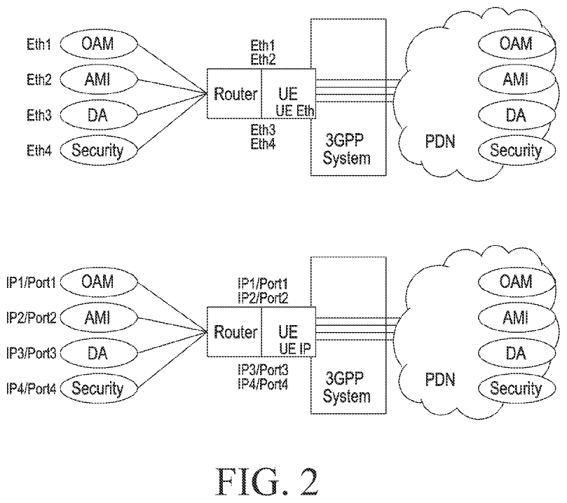

FIG. 2 is a view illustrating a conventional group communication scheme using 5GS.

Referring to FIG. 2, a UE needs to simultaneously support a plurality of group communications having different QoS requirements of various distributed applications. In this case, applications for smart energy are executed by multiple application clients to be connected to one UE. Since application data is encrypted and may not be identified by the UE, they should be able to perform group communication, with them distinguished by the respective Ethernet addresses Eth1, Eth2, Eth3, and Eth4 of the application clients as shown in FIG. 2(a), or with them distinguished by the respective IP addresses IP1, IP2, IP3, and IP4 of the application clients or IP address-port number combinations IP1/Port1, IP2/Port2, IP3/Port3, and IP4/Port4 as shown in FIG. 2(b).

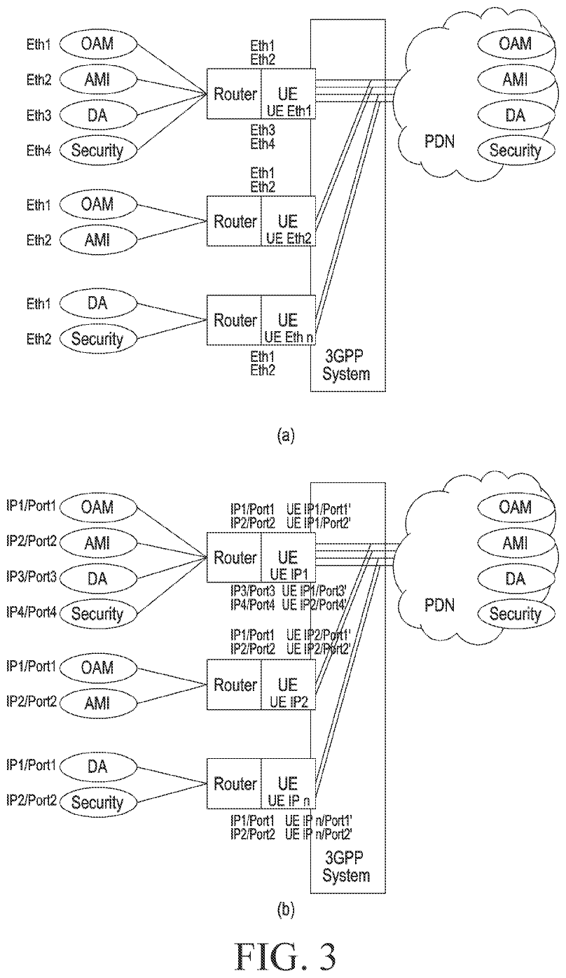

FIG. 3 is a view illustrating dynamic QoS/group mapping according to an embodiment of the disclosure.

FIG. 3(a) shows dynamic QoS/group mapping based on an Ethernet address. Referring to FIG. 3(a), when the application client where each application is executed for each UE is connected to the UE, the application clients may be mapped to different groups, respectively, using the respective Ethernet addresses of the application clients as identifiers. Upon setting up an Ethernet-based group communication PDU session, the Ethernet address of the server may be used as an identifier for identifying the applications. Or, the IP address or DNS name of the server may be used. In this case, the Ethernet-type PDU session may use the Ethernet addresses of the application clients instead of the Ethernet address of the UE.

FIG. 3(b) illustrates dynamic QoS/group mapping based on IP addresses or combinations of IP addresses and port numbers. Referring to FIG. 3(b), when the application clients where applications are executed for each UE are connected to the UE, the application clients may be mapped to different groups, respectively, using the respective IP addresses of the application clients as identifiers. Upon setting up an IP-based group communication PDU session, the IP address of the server may be used as an identifier for identifying the applications. Or, the DNS name may be used. In this case, since the UE IP address of the IP-type PDU session is not changeable, the IP address and port number (e.g., IP1/Port1) of the application client may be mapped to the IP address and port number (e.g., UE IP1/Port1′) of the UE and used.

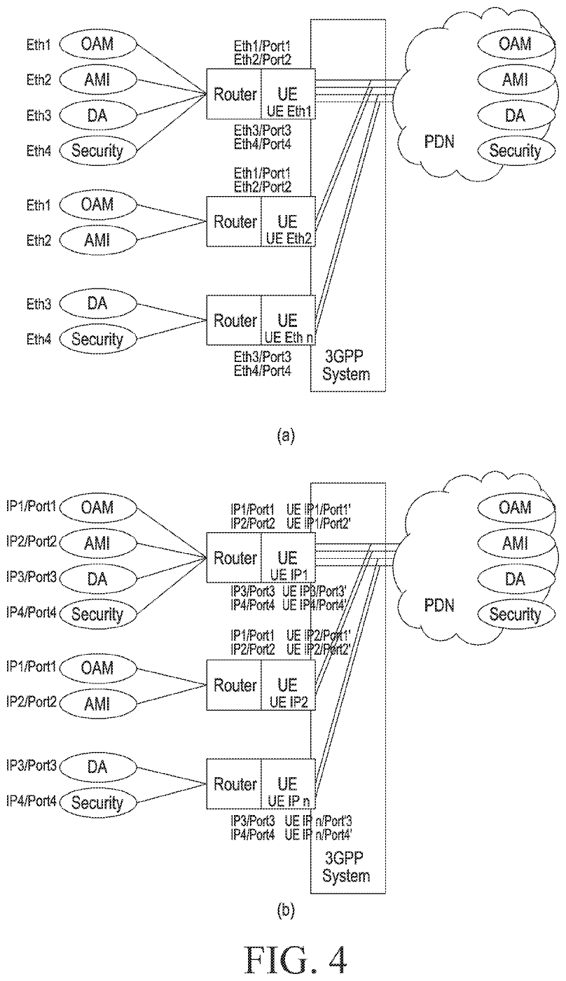

FIG. 4 is a view illustrating preset QoS/group mapping according to an embodiment of the disclosure.

FIG. 4(a) illustrates preset QoS/group mapping based on an Ethernet address or a port number mapped to the Ethernet address. Referring to FIG. 4(a), when the application clients where each application is executed for each UE are connected to the UE, the application clients may be mapped to different groups, respectively, using the respective Ethernet addresses of the application clients as identifiers. Upon setting up an Ethernet-based group communication PDU session, the Ethernet address of the server may be used as an identifier for identifying the applications. When the Ethernet address of the application client is preset, the Ethernet-type PDU session may use the Ethernet address of the UE and may use the Ethernet address of the application client or the port number mapped to the Ethernet address of the application client as the ID for identifying the group.

FIG. 4(b) illustrates preset QoS/group mapping based on IP addresses or combinations of IP addresses and port numbers. Referring to FIG. 4(b), when the application clients where applications are executed for each UE are connected to the UE, the application clients may be mapped to different groups, respectively, using the respective IP addresses of the application clients as identifiers. Upon setting up an IP-based group communication PDU session, the IP address of the server may be used as an identifier for identifying the applications. Or, the DNS name of the server may be used. In this case, since the UE IP address of the IP-type PDU session is not changeable, the IP address and port number (e.g., IP1/Port1) of the application client may be mapped to the IP address and port number (e.g., UE IP1/Port1′) of the UE and used.

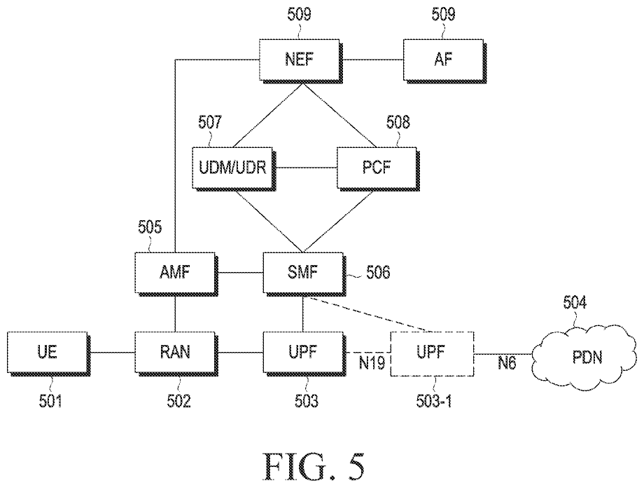

FIG. 5 is a view illustrating a 5GS structure for group configuration according to various embodiments of the disclosure.

Referring to FIG. 5, an application function (AF) 510 may request a network exposure function (NEF) 509 to create/change/delete a group or may transfer a message for requesting to add/change/delete a member to the group. The NEF 509 receiving the message from the AF 510 may transfer the content contained in the message to the UDR 507 through the UDM 507. When the group is created/changed/deleted, the UDR 707 may notify the PCF 508 of the UEs affected thereby of the same. The PCF 508 notified of the creation/change/deletion of the group from the UDR 507 may notify the SMF 506 of the same, and the SMF 506 may transmit the same to the UE 501 via the AMF 505 and the RAN 502. In this case, the UE 501 receiving the same from the SMF 506 may transfer a message for requesting to create/change/delete the PDU session corresponding to the group to the SMF 506 via the RAN 502 and the AMF 505. The SMF 506 receiving the message from the UE may identify subscription information for the UE 501 in the UDM/UDR 507 and then perform routing ad QoS configuration of the UPFs 503- and 503-1 through policy information for the UE 501, and transfer a response to the request for the PDU session to the UE 501 via the AMF 505 and the RAN 502. By using the so formed PDU session for the group, the traffic departing from the UE 501 may be transmitted to the necessary PDN 504 via the UPF 503, or transmitted to another UE in the UPF 503, or transfer to the UE connected to another UPF 503-1 via the N19 interface. Further, the traffic destined for the group from the PDN 504 may be forwarded to all UEs in the group, or some UEs meeting conditions, or a specific UE via the UPFs 503 and 503-1.

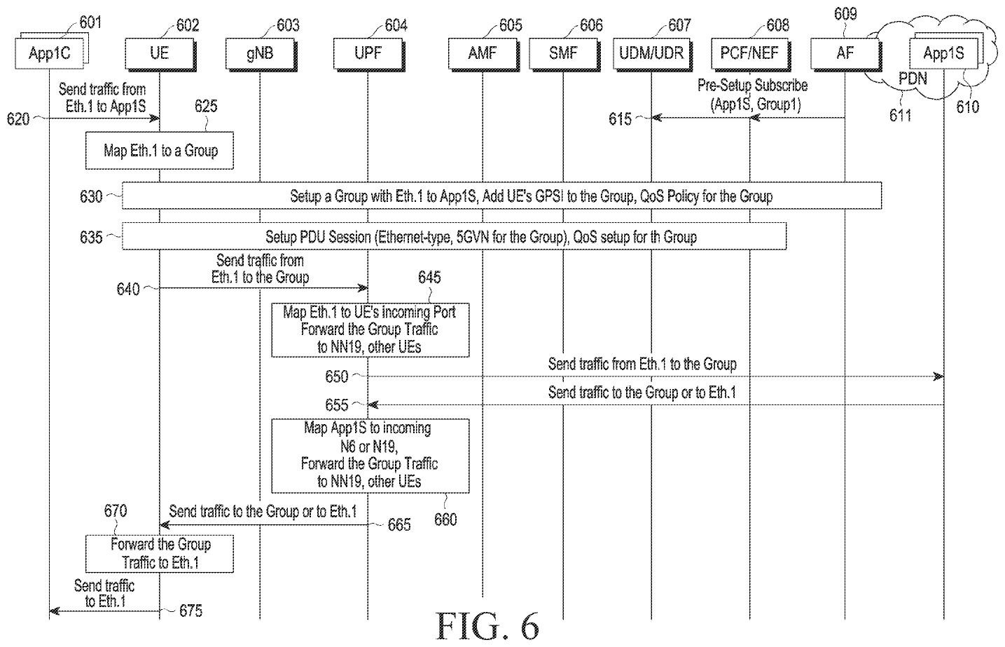

FIG. 6 is a view illustrating a method for performing dynamic QoS/group mapping based on an Ethernet address according to an embodiment of the disclosure.

Referring to FIG. 6, in step 615, the AF 609 may create group 1 for traffic destined for App1S (server of application 1) 610 in the PCF/NEF 608 and UDM/UDR 607, and complete subscription for requesting the PCF/NEF 608 and UDM/UDR 607 to notify of an event (change or delete) related to group 1. In this case, the AF 609 or PCF/NEF 608 may simply request to notify of reception of a request related to group 1 rather than previously creating group 1.

In step 620, the App1C (client of application 1) 601 having the Ethernet address of Eth.1 may transmit traffic destined for the App1S 610 to the UE 602.

In step 625, the UE 602 may map the address of Eth.1 to at least one preset group.

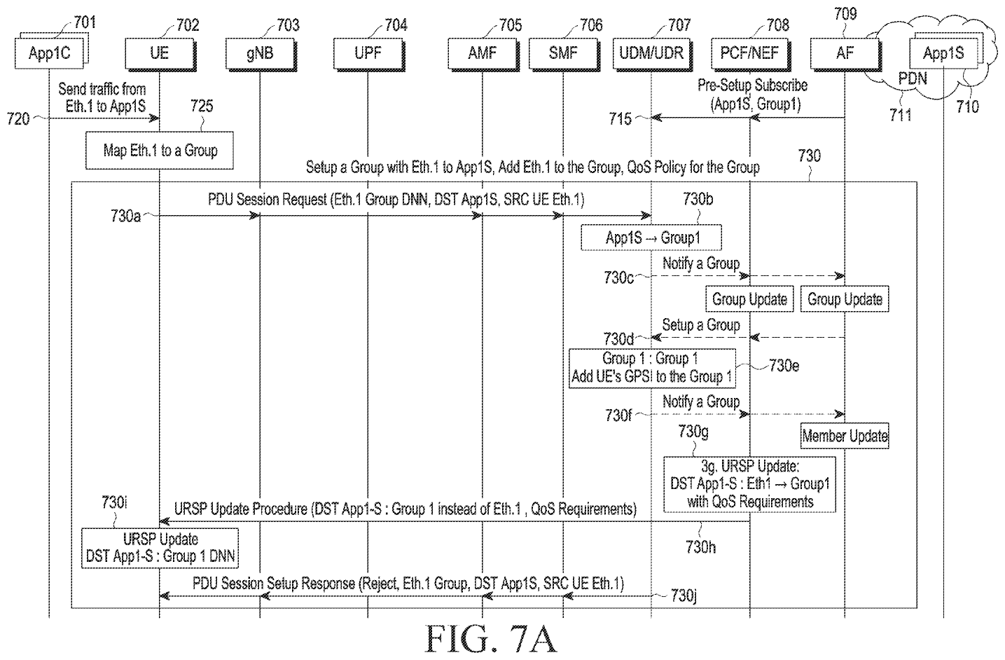

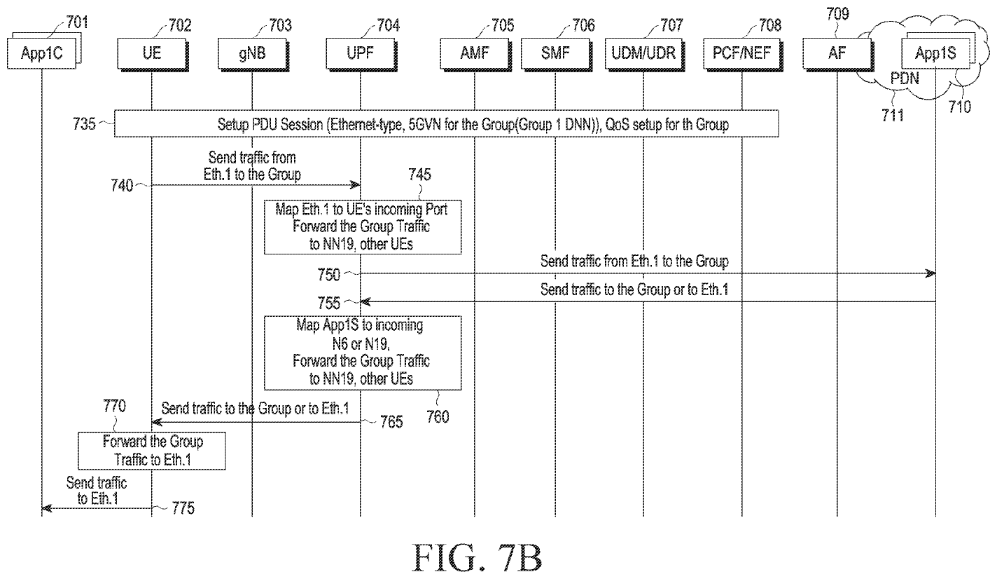

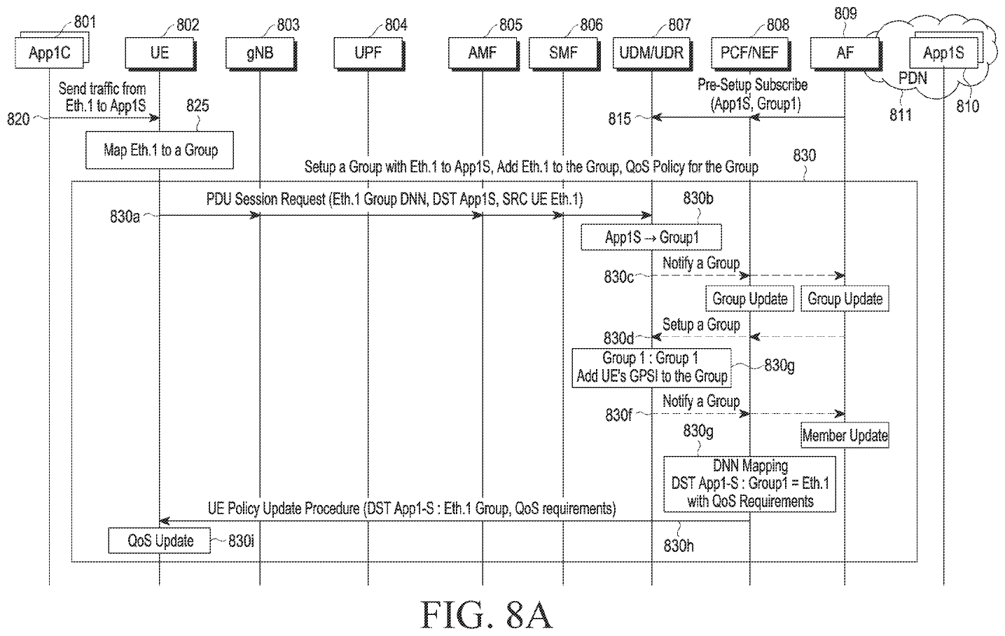

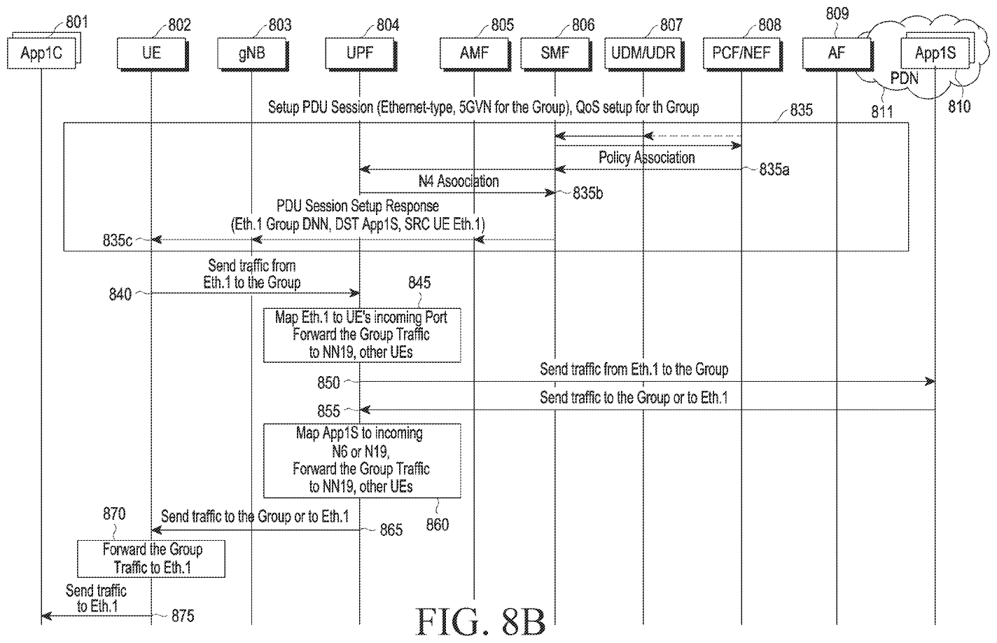

In step 630, when the at least one group is not created in step 625, the UE 602 may create the at least one group, may add the generic public subscription identifier (GPSI) of the UE 602 to the at least one group as a member, and may set a QoS policy required for the at least one group. In this case, it may be determined whether to use the at least one group as the group mapped to the address of Eth.1 as it is (e.g., the embodiment of FIGS. 8A and 8B) or to change to the group 1 (e.g., the embodiment of FIGS. 7A and 7B). The determination may be set by the AF 609 or the PCF/NEF 608 in step 615, or may be set in advance by the UDM/UDR 607.

In step 635, the UE 602 may establish a PDU session of which the PDU session type is Ethernet for the group determined in step 630, and may set a QoS of traffic for the group determined in step 630.

In step 640, the UE 602 may transmit the traffic received in step 620 to the UPF 604 via the base station 603 using the PDU session created in step 635.

In step 645, the UPF 604 may map Eth.1 to the incoming port of the UE 602 to prepare for future forwarding, and may identify the forwarding path to the packet data network (PDN) 611 in which the App1S 610 is positioned by directly transferring the received traffic to the N6 interface or by transferring the received traffic to the N6 interface via the N19 interface.

In step 650, the UPF 604 may transfer the traffic to the App1S 610 using the forwarding path identified in step 645.

In step 655, the App1S 610 may transmit traffic destined for the group determined in step 630 or the Ethernet address of Eth.1 to the UPF 604.

In step 660, the UPF 604 may identify the forwarding path as transmitting the traffic destined for the group determined in step 630 to all UEs of the group determined in step 630 or transmitting the traffic destined for the Ethernet address of Eth.1 in step 655 to the UE 602.

In step 665, the UPF 604 may transmit the traffic received from the App1S 610 to the UE 602 in step 655 using the forwarding path identified in step 660.

In step 670, the UE 602 may identify the forwarding path to transmit the traffic received from the UPF 604 to the App1C 601 having the Eth.1 address in step 665.

In step 675, the UE 602 may transmit the traffic received from the UPF 604 in step 665 to the App1C 601 having the Eth. 1 address using the forwarding path identified in step 670.

FIGS. 7A and 7B are views illustrating a method for performing dynamic QoS/group mapping based on an Ethernet address using a PDU session reject procedure according to an embodiment of the disclosure.

Referring to FIGS. 7A and 7B, in step 715, the AF 709 may create group 1 for traffic destined for App1S 710 in the PCF/NEF 708 and UDM/UDR 707, and complete subscription for requesting the PCF/NEF 708 and UDM/UDR 707 to notify of an event (change or delete) related to group 1. In this case, the AF 709 or PCF/NEF 708 may simply request to notify of reception of a request related to group 1 rather than previously creating group 1.

In step 720, the App1C 701 having the Ethernet address of Eth.1 may transmit traffic destined for the App1S 710 to the UE 702.

In step 725, the UE 702 may map the address of Eth.1 to at least one preset group.

In step 730, when the at least one group is not created in step 725, the UE 702 may create the at least one group, may add the GPSI of the UE 702 to the at least one group as a member, and may set a QoS policy required for the at least one group. The specific procedure of step 730 is as follows.

In step 730a, the UE 702 may transmit a message for requesting PDU session setup to the SMF 706 via the base station 703 and the AMF 705. In this case, the data network name (DNN) included in the message requesting the PDU session setup may indicate the at least one group mapped to Eth.1, the destination address may indicate the Ethernet address or the IP address of the App1S 710, and the source address may indicate Eth.1. Further, the DNS name of the App1S 710 may be used as it is, or the DNS name of the App1S 710 may be changed to an IP address or an Ethernet address before step 730a. In this case, the SMF 706 may notify the UDM/UDR 707 that the group for the traffic destined for the App1S 710 is requested for PDU session setup to the at least one group mapped to Eth. 1, e.g., for identifying subscription.

In step 730b, the UDM/UDR 707 may identify that group 1 corresponds to a group of traffic destined for the APP1S 710 by searching based on the App1S 710.

In step 730c, the UDM/UDR 707 may notify the PCF/NEF 708 and/or the AF 709 that traffic toward the App1S 710 has occurred, in consideration of the subscribed information about the AF 709 in step 715. The PCF/NEF 708 receiving the corresponding notification from the UDM/UDR 707 may update the information related to group 1, and the AF 709 receiving the corresponding notification from the UDM/UDR 707 may update the information related to group 1. For example, if the group 1 is not created in step 715, the AF 709 may change the state to create the group 1.

In step 730d, if necessary, the AF 709 may request the UDM/UDR 707 to create the group 1 via the PCF/NEF 708.

In step 730e, the UDM/UDR 707 may create the group 1 or, when the group 1 has already been created, may add the GPSI of the UE 702 to the group 1 as a member.

In step 730f, the UDM/UDR 707 may notify the PCF/NEF 708 and the AF 709 that the GPSI of the UE 702 is added to the group 1 as a member. Upon receiving the corresponding notification from the UDM/UDR 707, the AF 709 may perform an update so that the GPSI of the UE 702 is added to the members of the group 1. Further, the AF 709 may notify the PCF/NEF 708 that the update of Group 1 has been completed.

In step 730g, the PCF/NEF 708 may update the UE route selection policy (URSP) for the UE 702. In this case, the PCF/NEF 708 may map the traffic having the App1S 710 as the destination to the group 1 rather than the at least one group mapped to Eth. 1, and may perform an update to use the QoS allocated to the group 1.

In step 730h, the PCF 708 may transfer the updated content in step 730g to the UDR/UDM 707 and may transfer a message requesting for performing a URSP update with the updated content in step 730g to the UE 702.

In step 730i, when the destination address is App1S 710, the UE 702 may update the URSP such that the group 1 is used as the DNN instead of the at least one group.

In step 730j, the UDM/UDR 707 may transmit a response indicating that the at least one group mapped to Eth.1 may not be used as a DNN to the SMF 706, and accordingly, the SMF 706 may transmit, as a PDU session response, a response message for rejecting the PDU session setup request in step 730a to the UE 702. In this case, an error cause may be added to the response message so that the UE 702 attempts the PDU session setup request procedure again using the updated URSP.

In step 735, the UE 702 may perform a PDU session setup procedure using the group 1 as a DNN to create a PDU session for the group 1 of which the PDU session type is Ethernet, and may set the QoS allocated to the group 1 as it is.

In step 740, the UE 702 may transmit the traffic received in step 720 to the UPF 704 via the base station 703 using the PDU session created in step 735.

In step 745, the UPF 704 may map Eth.1 to the incoming port of the UE 702 to prepare for future forwarding, and may identify the forwarding path to the PDN 711 in which the App1S 710 is positioned by directly transferring the received traffic to the N6 interface or by transferring the received traffic to the N6 interface via the N19 interface.

In step 750, the UPF 704 may transfer the traffic to the App1S 710 using the forwarding path identified in step 745.

In step 755, the App1S 710 may transmit traffic destined for the group 1 or the Ethernet address of Eth.1 to the UPF 704.

In step 760, the UPF 704 may identify the forwarding path as transmitting the traffic destined for the group 1 in step 755 to all UEs of the group 1 or transmitting the traffic destined for the Ethernet address of Eth. 1 in step 755 to the UE 702.

In step 765, the UPF 704 may transmit the traffic received from the App1S 710 to the UE 702 in step 755 using the forwarding path identified in step 760.

In step 770, the UE 702 may identify the forwarding path to transmit the traffic received from the UPF 704 to the App1C 701 having the Eth.1 address in step 765.

In step 775, the UE 702 may transmit the traffic received from the UPF 704 in step 765 to the App1C 701 having the Eth. 1 address using the forwarding path identified in step 770.

FIGS. 8A and SB are views illustrating a method for performing dynamic QoS/group mapping based on an Ethernet address using a PDU session change procedure according to an embodiment of the disclosure.

Referring to FIGS. 8A and 8B, in step 815, the AF 809 may create group 1 for traffic destined for App1S 810 in the PCF/NEF 808 and UDM/UDR 807, and complete subscription for requesting the PCF/NEF 808 and UDM/UDR 807 to notify of an event (change or delete) related to group 1. In this case, the AF 809 or PCF/NEF 808 may simply request to notify of reception of a request related to group 1 rather than previously creating group 1.

In step 820, the App1C 801 having the Ethernet address of Eth.1 may transmit traffic destined for the App1S 810 to the UE 802.

In step 825, the UE 802 may map the address of Eth. 1 to at least one preset group.

In step 830, when the at least one group is not created in step 825, the UE 802 may create the at least one group, may add the GPSI of the UE 802 to the at least one group as a member, and may set a QoS policy required for the at least one group. The specific procedure of step 830 is as follows.

In step 830a, the UE 802 may transmit a message for requesting PDU session setup to the SMF 806 via the base station 803 and the AMF 805. In this case, the DNN included in the message requesting the PDU session setup may indicate the at least one group mapped to Eth.1, the destination address may indicate the Ethernet address or the IP address of the App1S 810, and the source address may indicate Eth.1. Further, the DNS name of the App1S 810 may be used as it is, or the DNS name of the App1S 810 may be changed to an IP address or an Ethernet address before step 830a. In this case, the SMF 806 may notify the UDM/UDR 807 that the group for the traffic destined for the App1S 810 is requested for PDU session setup to the at least one group mapped to Eth. 1. e.g., for identifying subscription.

In step 830b, the UDM/UDR 807 may identify that group 1 corresponds to a group of traffic destined for the App1S 810 by searching based on the App1S 810.

In step 830c, the UDM/UDR 807 may notify the PCF/NEF 808 and/or the AF 809 that traffic toward the App1S 810 has occurred, in consideration of the subscribed information about the AF 809 in step 815. The PCF/NEF 808 receiving the corresponding notification from the UDM/UDR 807 may update the information related to group 1, and the AF 809 receiving the corresponding notification from the UDM/UDR 807 may update the information related to group 1. For example, if the group 1 is not created in step 815, the AF 809 may change the state to create the group 1.

In step 830d, if necessary, the AF 809 may request the UDM/UDR 807 to create the group 1 via the PCF/NEF 808.

In step 830e, the UDM/UDR 807 may create the group 1 or, when the group 1 has already been created, may add the GPSI of the UE 802 to the group 1 as a member.

In step 830f, the UDM/UDR 807 may notify the PCF/NEF 808 and the AF 809 that the GPSI of the UE 802 is added to the group 1 as a member. Upon receiving the corresponding notification from the UDM/UDR 807, the AF 809 may perform an update so that the GPSI of the UE 802 is added to the members of the group 1. Further, the AF 809 may notify the PCF/NEF 808 that the update of Group 1 has been completed.

In step 830g, the PCF/NEF 808 may set up DNN mapping. The PCF/NEF 808 may be configured to map traffic destined for the App1S 810 to the at least one group mapped to Eth. 1, map the at least one group to be the same DNN as the group 1, and use the QoS allocated to the group 1 as the QoS for the at least one group.

In step 830h, the PCF 808 may transfer the content set in step 830g to the UDR/UDM 807 and may transfer a message requesting for performing a QoS update with the content set in step 830g to the UE 802.

In step 830i, when the destination address is App1S 810, the UE 802 may use the at least one group mapped to Eth.1 and may update the internal settings to be the QoS allocated to the group 1 according to steps 830g and 830h as the QoS for the at least one group at this time.

In step 835, the UE 802 may perform a PDU session setup procedure using the group 1 as a DNN to create a PDU session for the at least one group of which the PDU session type is Ethernet. and may set the QoS for the at least one group with the QoS allocated to the group 1. The specific procedure of step 835 is as follows.

In step 835a, the PCF/NEF 808 may notify the UDM/UDR 807 of the content set in step 830g. The UDM/UDR 807 may transfer a response indicating that the at least one group mapped to Eth.1 may be used as a DNN for the PDU session setup request to the SMF 806, and the SMF 806 may accordingly perform an association procedure with the related PCF 808. In this case, the SMF 806 may receive routing and QoS configuration for the at least one group mapped to Eth.1 from the PCF 808 with the same contents as those of the group 1.

In step 835b, the SMF 806 may perform routing and configuration for the QoS received from the UPF 804 in step 835a.

In step 835c, the SMF 806 may transfer a response to the message for requesting PDU session setup in step 830a to the UE 802 to complete PDU session establishment, and may apply the related QoS configuration to the UE 802 and the base station 803 node.

In step 840, the UE 802 may transmit the traffic received in step 820 to the UPF 804 via the base station 803 using the PDU session created in step 835.

In step 845, the UPF 804 may map Eth.1 to the incoming port of the UE 802 to prepare for future forwarding, and may identify the forwarding path to the PDN 811 in which the App1S 810 is positioned by directly transferring the received traffic to the N6 interface or by transferring the received traffic to the N6 interface via the N19 interface.

In step 850, the UPF 804 may transfer the traffic to the App1S 810 using the forwarding path identified in step 845.

In step 855, the App1S 810 may transmit traffic destined for the at least one group or the Ethernet address of Eth. 1 to the UPF 804.

In step 860, the UPF 804 may identify the forwarding path as transmitting the traffic destined for the at least one group in step 855 to all UEs of the at least one group or transmitting the traffic destined for the Ethernet address of Eth.1 in step 855 to the UE 802.

In step 865, the UPF 804 may transmit the traffic received from the App1S 810 to the UE 802 in step 855 using the forwarding path identified in step 860.

In step 870, the UE 802 may identify the forwarding path to transmit the traffic received from the UPF 804 to the App1C 801 having the Eth. 1 address in step 865.

In step 875, the UE 802 may transmit the traffic received from the UPF 804 in step 865 to the App1C 801 having the Eth.1 address using the forwarding path identified in step 870.

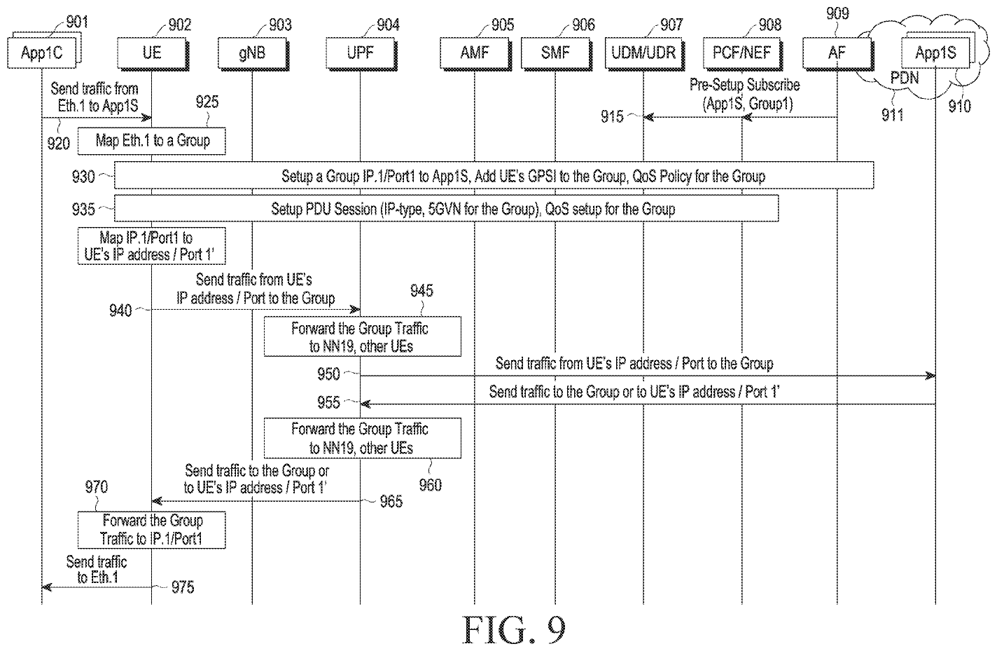

FIG. 9 is a view illustrating a method for performing dynamic QoS/group mapping based on an IP address according to an embodiment of the disclosure.

Referring to FIG. 9, in step 915, the AF 909 may previously create group 1 for traffic destined for App1S 910 in the PCF/NEF 908 and UDM/UDR 907, and complete subscription for requesting the PCF/NEF 908 and UDM/UDR 907 to notify of an event (change or delete) related to group 1. In this case, the AF 909 or PCF/NEF 908 may simply request to notify of reception of a request related to group 1 rather than previously creating group 1.

In step 920, the App1C 901 having the IP address of IP.1 may transmit traffic destined for the App1S 910 to the UE 902. The traffic destined for the App1S 910 may be transmitted from the App1C 901 having the IP.1 address and port 1.

In step 925, the UE 902 may map IP.1/port 1 to at least one preset group.

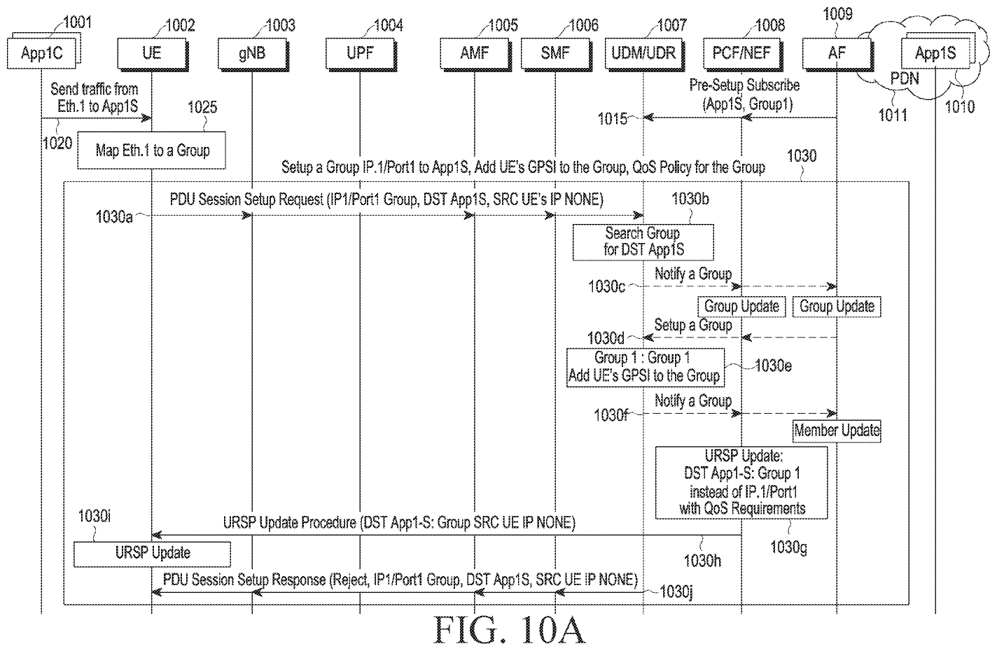

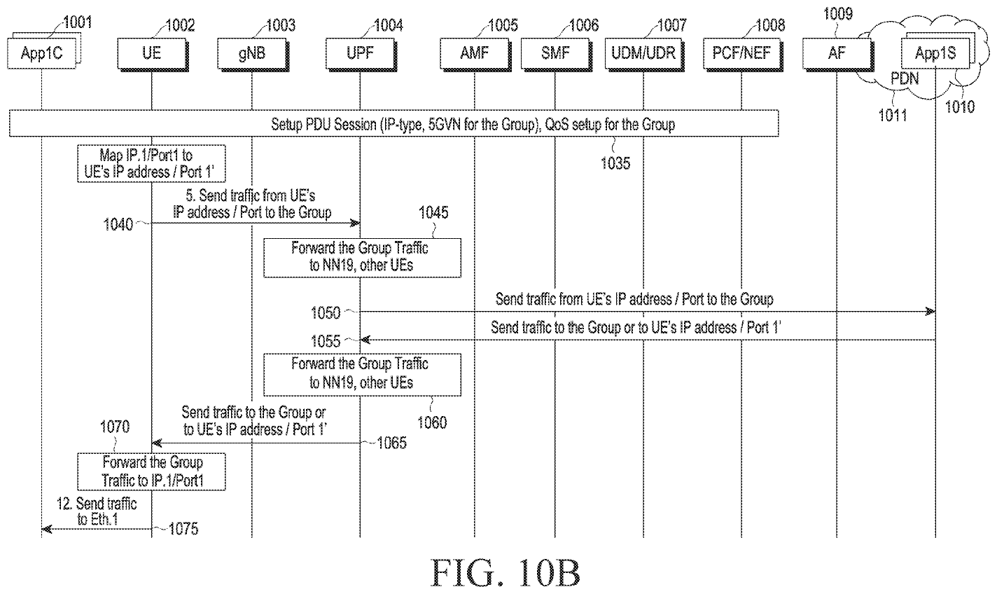

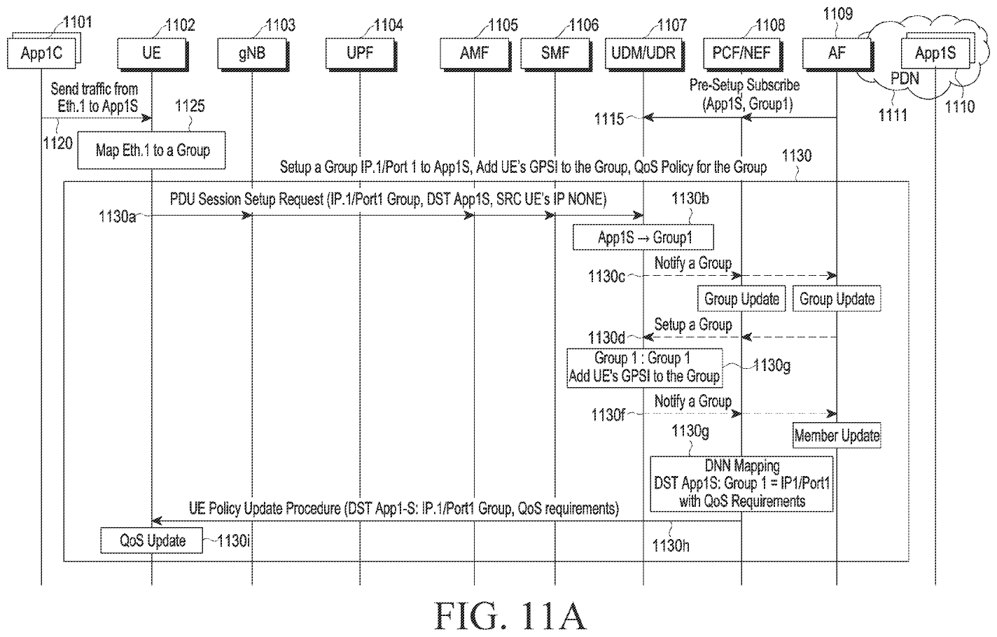

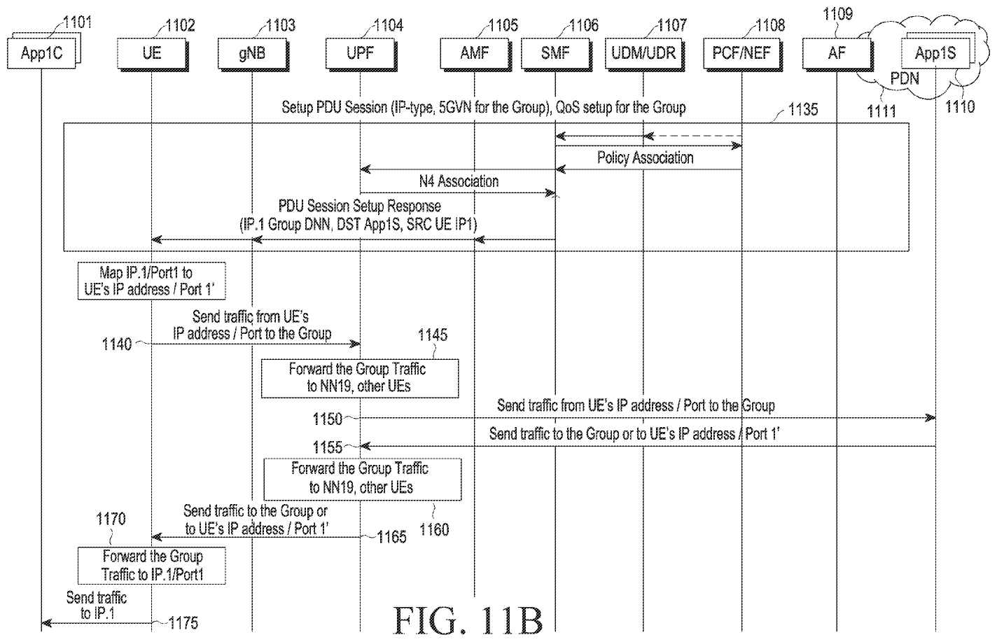

In step 930, when the at least one group is not created in step 925, the UE 902 may create the at least one group, may add the GPSI of the UE 902 to the at least one group as a member, and may set a QoS policy required for the at least one group. In this case, it may be determined whether to maintain the group mapped to IP.1/port 1 as the at least one group (e.g., the embodiment of FIGS. 11A and 11B) or to change the group to the group 1 (e.g., the embodiment of FIGS. 10A and 10B). The determination may be set by the AF 909 or the PCF/NEF 908 in step 915, or may be set in advance by the UDM/UDR 907.

In step 935, the UE 902 may establish a PDU session of which the PDU session type is Ethernet for the group determined in step 930, and may set a QoS for the group determined in step 930. The UE 902 may map IP.1/port 1 to the IP address of the UE 902 and the port of the UE 902, i.e., port 1′. In step 940, the UE 902 may transmit the traffic received in step 920 to the UPF 904 via the base station 903 using the PDU session created in step 935.

In step 945, the UPF 904 may identify the forwarding path to the PDN 911 in which the App1S 910 is positioned by directly transferring the traffic received from the UE 902 to the N6 interface or by transferring the received traffic to the N6 interface via the N19 interface.

In step 950, the UPF 904 may transfer the traffic to the App1S 910 using the forwarding path identified in step 945.

In step 955, the App1S 910 may transmit traffic destined for the group determined in step 930 or the IP address and port 1′ of the UE 902 to the UPF 904.

In step 960, the UPF 904 may identify the forwarding path as transmitting the traffic destined for the group determined in step 930 to all UEs of the group determined in step 930 or transmitting the traffic destined for the IP address of the UE 1002 to the UE 902.

In step 965, the UPF 904 may transmit the traffic received from the App1S 910 to the UE 902 in step 955 using the forwarding path identified in step 960.

In step 970, the UE 902 may identify the forwarding path to transmit the traffic destined for the IP address and port 1′ of the UE 902, received from the UPF 904 in step 965 to port 1 of the App1C 901 having the IP.1 address. In this case, the UE 902 may use the information mapped in step 935.

In step 975, the UE 902 may transmit the traffic destined for the IP address and port 1′ of the UE 902, received from the UPF 904 in step 965 to port 1 of the App1C 901 having the IP.1 address using the forwarding path identified in step 970.

FIGS. 10A and 10B are views illustrating a method for performing dynamic QoS/group mapping based on an IP address using a PDU session reject procedure according to an embodiment of the disclosure.

Referring to FIGS. 10A and 10B, in step 1015, the AF 1009 may create group 1 for traffic destined for App1S 1010 in the PCF/NEF 1008 and UDM/UDR 1007, and complete subscription for requesting the PCF/NEF 1008 and UDM/UDR 1007 to notify of an event (change or delete) related to group 1. In this case, the AF 1009 or PCF/NEF 1008 may simply request to notify of reception of a request related to group 1 rather than creating group 1.

In step 1020, the device having the IP address of IP.1 transmits the traffic destined for App1S (server of Application1) to the UE. The traffic is transmitted from the App1C (client of Application1) having the IP.1 address and Port1.

In step 1025, the UE 1002 may map IP.1/port 1 to at least one preset group.

In step 1030, when the at least one group is not created in the step, the UE 1002 may create the at least one group, may add the GPSI of the UE 1002 to the at least one group as a member, and may set a QoS policy required for the at least one group. The specific procedure of step 1030 is as follows.

In step 1030a, the UE 1002 may transmit a message for requesting PDU session setup to the SMF 1006 via the base station 1003 and the AMF 1005. In this case, the DNN included in the message requesting the PDU session setup may indicate the at least one group mapped to IP.1/port 1, the destination address may indicate the DNS name or IP address of the App1S 1010, and the source address may indicate the IP (NONE) address of the UE 1002. Further, the DNS name of the App1S 1010 may be used as it is, or the DNS name of the App1S 1010 may be changed to an IP address before step 1030a. In this case, the SMF 1006 may notify the UDM/UDR 1007 that the group for the traffic destined for the App1S 1010 is requested for PDU session setup to the at least one group mapped to IP.1/port 1, e.g., for identifying subscription.

In step 1030b, the UDM/UDR 1007 may identify that group 1 corresponds to a group of traffic destined for the APP1S 710 by searching based on the App1S 1010.

In step 1030c, the UDM/UDR 1007 may notify the PCF/NEF 1008 and/or the AF 1009 that traffic toward the App1S 1010 has occurred, in consideration of the subscribed information about the AF 1009 in step 1015. The PCF/NEF 1008 receiving the corresponding notification from the UDM/UDR 1007 may update the information related to group 1, and the AF 1009 receiving the corresponding notification from the UDM/UDR 1007 may update the information related to group 1. For example, if the group 1 is not created in step 1015, the AF 1009 may change the state to create the group 1.

In step 1030d, if necessary, the AF 1009 may request the UDM/UDR 1008 to create the group 1 via the PCF/NEF 1008.

In step 1030e, the UDM/UDR 1007 may create the group 1 or, when the group 1 has already been created, may add the GPSI of the UE 1002 to the group 1 as a member.

In step 1030f, the UDM/UDR 1007 may notify the PCF/NEF 1008 and the AF 1009 that the GPSI of the UE 1002 is added to the group 1 as a member. Upon receiving the corresponding notification from the UDM/UDR 1007, the AF 1009 may perform an update so that the GPSI of the UE 1002 is added to the members of the group 1. Further, the AF 1009 may notify the PCF/NEF 1008 that the update of Group 1 has been completed.

In step 1030g, the PCF/NEF 1008 may update the URSP for the UE 1002. In this case, the PCF/NEF 1008 may map the traffic having the App1S 1010 as the destination to the group 1 rather than the at least one group mapped to IP.1/port 1, and may perform an update to use the QoS allocated to the group 1.

In step 1030h, the PCF 1008 may transfer the updated content in step 730g to the UDR/UDM 1007 and may transfer a message requesting for performing a URSP update with the updated content in step 1030g to the UE 1002.

In step 1030i, when the destination address is App1S 1010, the UE 1002 may update the URSP such that the group 1 is used as the DNN instead of the at least one group.

In step 1030j, the UDM/UDR 1007 may transmit a response indicating that the at least one group mapped to IP.1/port 1 may not be used as a DNN to the SMF 1006, and accordingly, the SMF 1006 may transmit, as a PDU session response, a response message for rejecting the PDU session setup request in step 1030a to the UE 702. In this case, an error cause may be added to the response message so that the UE 1002 attempts the PDU session setup request procedure again using the updated URSP.

In step 1035, the UE 1002 may perform a PDU session setup procedure using the group 1 as a DNN to create a PDU session for the group 1 of which the PDU session type is Ethernet, and may set the QoS allocated to the group 1 as it is. Further, the UE 1002 may map IP.1/port 1 to the IP address of the UE 1002 and port 1′, which is the port of the UE 1002. In step 1040, the UE 1002 may transmit the traffic received in step 1020 to the UPF 1004 via the base station 1003 using the PDU session created in step 1035.

In step 1045, the UPF 1004 may identify the forwarding path to the PDN 1011 in which the App1S 1010 is positioned by directly transferring the traffic received from the UE 1002 to the N6 interface or by transferring the received traffic to the N6 interface via the N19 interface.

In step 1050, the UPF 1004 may transfer the traffic to the App1S 1010 using the forwarding path identified in step 1045.

In step 1055, the App1S 1010 may transmit traffic destined for the at least one group or the IP address and port 1′ of the UE 1002 to the UPF 1004.

In step 1060, the UPF 1004 may identify the forwarding path as transmitting the traffic destined for the at least one group to all UEs of the group 1 or transmitting the traffic destined for the IP address of the UE 1002 to the UE 1002.

In step 1065, the UPF 1004 may transmit the traffic received from the App1S 1010 to the UE 1002 in step 1055 using the forwarding path identified in step 1060.

In step 1070, the UE 1002 may identify the forwarding path to transmit the traffic destined for the IP address and port 1′ of the UE 1002, received from the UPF 1004 in step 1065 to port 1 of the App1C 1001 having the IP.1 address. In this case, the UE 1002 may use the information mapped in step 1035.

In step 1075, the UE 1002 may transmit the traffic destined for the IP address and port 1′ of the UE 1002, received from the UPF 1004 in step 1065 to port 1 of the App1C 1001 having the IP.1 address using the forwarding path identified in step 1070.

FIGS. 11A and 11B are views illustrating a method for performing dynamic QoS/group mapping based on an IP address using a PDU session change procedure according to an embodiment of the disclosure.

Referring to FIGS. 11A and 11B, in step 1115, the AF 1109 may create group 1 for traffic destined for App1S 1110 in the PCF/NEF 1108 and UDM/UDR 1107, and complete subscription for requesting the PCF/NEF 1108 and UDM/UDR 1107 to notify of an event (change or delete) related to group 1. In this case, the AF 1109 or PCF/NEF 1108 may simply request to notify of reception of a request related to group 1 rather than previously creating group 1.

In step 1120, the App1C 1101 having the IP address of IP.1 may transmit traffic destined for the App1S 1110 to the UE 1102. In this case, the traffic destined for the App1S 1110 may be transmitted from the App1C 1101 having the IP.1 address and port 1.

In step 1125, the UE 1102 may map IP.1/port 1 to at least one preset group.

In step 1130, when the at least one group is not created in step 1125, the UE 1102 may create the at least one group, may add the GPSI of the UE 1102 to the at least one group as a member, and may set a QoS policy required for the at least one group. The specific procedure of step 1130 is as follows.

In step 1130a, the UE 1102 may transmit a message for requesting PDU session setup to the SMF 1106 via the base station 1103 and the AMF 1105. In this case, the DNN included in the message requesting the PDU session setup may indicate the at least one group mapped to IP.1/port 1, the destination address may indicate the DNS name or IP address of the App1S 1110, and the source address may indicate the IP (NONE) address of the UE 1102. Further, the DNS name of the App1S 1110 may be used as it is, or the DNS name of the App1S 1110 may be changed to an IP address before step 1130a. In this case, the SMF 1106 may notify the UDM/UDR 1107 that the group for the traffic destined for the App1S 1110 is requested for PDU session setup to the at least one group mapped to IP.1/port 1, e.g., for identifying subscription.

In step 1130b, the UDM/UDR 1107 may identify that group 1 corresponds to a group of traffic destined for the App1S 1110 by searching based on the App1S 1110.

In step 1130c, the UDM/UDR 1107 may notify the PCF/NEF 1108 and/or the AF 1109 that traffic toward the App1S 1110 has occurred, in consideration of the subscribed information about the AF 1109 in step 1115. The PCF/NEF 1108 receiving the corresponding notification from the UDM/UDR 1107 may update the information related to group 1, and the AF 1109 receiving the corresponding notification from the UDM/UDR 1107 may update the information related to group 1. For example, if the group 1 is not created in step 1115, the AF 1109 may change the state to create the group 1.

In step 1130d, if necessary, the AF 1109 may request the UDM/UDR 1107 to create the group 1 via the PCF/NEF 1108.

In step 1130e, the UDM/UDR 1107 may create the group 1 or, when the group 1 has already been created, may add the GPSI of the UE 1102 to the group 1 as a member.

In step 1130f, the UDM/UDR 1107 may notify the PCF/NEF 1108 and the AF 1109 that the GPSI of the UE 1102 is added to the group 1 as a member. Upon receiving the corresponding notification from the UDM/UDR 1107, the AF 1109 may perform an update so that the GPSI of the UE 1102 is added to the members of the group 1. Further, the AF 1109 may notify the PCF/NEF 1108 that the update of Group 1 has been completed.

In step 1130g, the PCF/NEF 1108 may set up DNN mapping. The PCF/NEF 1108 may be configured to map traffic destined for the App1S 1110 to the at least one group mapped to IP.1/port 1, map the at least one group to be the same DNN as the group 1, and use the QoS allocated to the group 1 as the QoS for the at least one group.

In step 1130h, the PCF 1108 may transfer the content set in step 1130g to the UDR/UDM 1107 and may transfer a message requesting for performing a QoS update with the content set in step 1130g to the UE 1102.

In step 1130i, when the destination address is App1S 1110, the UE 1102 may use the at least one group mapped to IP.1/port 1 and may update the internal settings to be the QoS allocated to the group 1 according to steps 1130g and 1130h as the QoS for the at least one group at this time.

In step 1135, the UE 1102 may perform a PDU session setup procedure using the group 1 as a DNN to create a PDU session for the at least one group of which the PDU session type is IP, and may set the QoS for the at least one group with the QOS allocated to the group 1. The specific procedure of step 1135 is as follows.

In step 1135a, the PCF/NEF 1108 may notify the UDM/UDR 1107 of the content set in step 1130g. The UDM/UDR 1107 may transfer a response indicating that the at least one group mapped to IP.1/port 1 may be used as a DNN for the PDU session setup request to the SMF 1106, and the SMF 1106 may accordingly perform an association procedure with the related PCF 1108. In this case, the SMF 1106 may receive routing and QoS configuration for the at least one group mapped to IP.1/port 1 from the PCF 1108 with the same contents as those of the group 1.

In step 1135b, the SMF 1106 may perform routing and QoS configuration received from the UPF 1104 in step 1135a.

In step 1135c, the SMF 1106 may transfer a response to the message for requesting PDU session setup in step 1130a to the UE 1102 to complete PDU session establishment, and may apply the related QoS configuration to the UE 1102 and the base station 1103 node.

In step 1140, the UE 1102 may transmit the traffic received in step 1120 to the UPF 1104 via the base station 1103 using the PDU session created in step 1135.

In step 1145, the UPF 1104 may identify the forwarding path to the PDN 1111 in which the App1S 1110 is positioned by directly transferring the traffic received from the UE 1102 to the N6 interface or by transferring the received traffic to the N6 interface via the N19 interface.

In step 1150, the UPF 1104 may transfer the traffic to the App1S 1110 using the forwarding path identified in step 1045.

In step 1155, the App1S 1110 may transmit traffic destined for the at least one group or the IP address and port 1′ of the UE 1102 to the UPF 1104.

In step 1160, the UPF 1104 may identify the forwarding path as transmitting the traffic destined for the at least one group to all UEs of the at least one group or transmitting the traffic destined for the IP address of the UE 1102 to the UE 1102.

In step 1165, the UPF 1104 may transmit the traffic received from the App1S 1110 to the UE 1102 in step 1155 using the forwarding path identified in step 1160.

In step 1170, the UE 1102 may identify the forwarding path to transmit the traffic destined for the IP address and port 1′ of the UE 1102, received from the UPF 1104 in step 1165 to port 1 of the App1C 1101 having the IP.1 address. In this case, the UE 1102 may use the information mapped in step 1135.

In step 1175, the UE 1102 may transmit the traffic destined for the IP address and port 1′ of the UE 1102, received from the UPF 1104 in step 1165 to port 1 of the App1C 1101 having the IP.1 address using the forwarding path identified in step 1170.

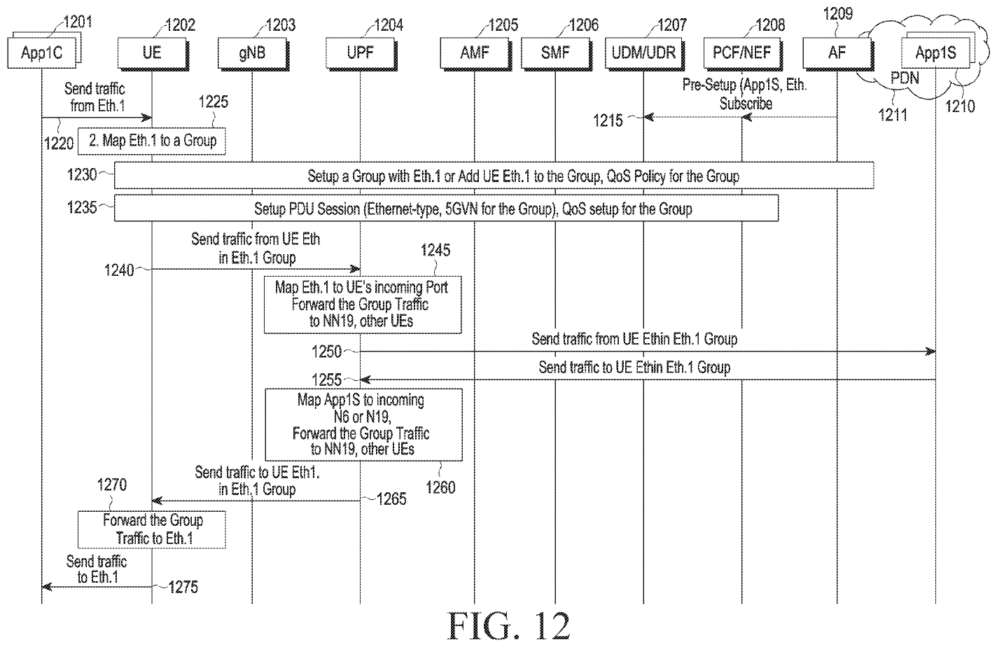

FIG. 12 is a view illustrating a method for performing preset QoS/group mapping based on an Ethernet address according to an embodiment of the disclosure.

Referring to FIG. 12, in step 1215, the AF 1209 may previously create a group mapped to the Eth.1 address for traffic destined for App1S 1210 in the PCF/NEF 1208 and UDM/UDR 1207, and complete subscription for requesting the PCF/NEF 1208 and UDM/UDR 1207 to notify of an event (change or delete) related to the group mapped to the Eth.1 address. In this case, the AF 1209 or PCF/NEF 1208 may simply request to notify of reception of a request related to the group mapped to the Eth.1 address rather than previously creating the group mapped to the Eth. 1 address.

In step 1220, the App1C 1201 having the Ethernet address of Eth.1 may transmit traffic destined for the App1S 1210 to the UE 1202. In this case, the App1C 1201 may be previously configured to have Eth. 1 as the Ethernet address.

In step 1225, the UE 1202 may map the address of Eth.1 to at least one preset group.

In step 1230, when the at least one group is not created in step 1225, the UE 1202 may create the at least one group, may add the GPSI of the UE 1202 to the at least one group as a member, and may set a QoS policy required for the at least one group. Since step 1230 is similar to steps 830a to 830j of FIG. 8, but the DNN is previously set as the group mapped to Eth. 1, the group mapped to Eth.1 may be used, as it is, as the DNN without DNN mapping.

In step 1235, the UE 1202 may perform a PDU session setup procedure using the group mapped to Eth.1 as a DNN to create a PDU session for the at least one group of which the PDU session type is Ethernet, and may set the QoS for the at least one group with the QoS allocated to the group mapped to Eth. 1.

In step 1240, the UE 1202 may transmit the traffic received in step 1215 to the UPF 1204 via the base station 1203 using the PDU session created in step 1235.

In step 1245, the UPF 1204 may map Eth.1 to the incoming port of the UE 1202 to prepare for future forwarding, and may identify the forwarding path to the PDN 1211 in which the App1S 1210 is positioned by directly transferring the received traffic to the N6 interface or by transferring the received traffic to the N6 interface via the N19 interface.

In step 1250, the UPF 1205 may transfer the traffic to the App1S 1210 using the forwarding path identified in step 1245.

In step 1255, the App1S 1210 may transmit traffic destined for the at least one group or the Ethernet address of Eth.1 to the UPF 1204.

In step 1260, the UPF 1204 may identify the forwarding path as transmitting the traffic destined for the at least one group in step 1255 to all UEs of the at least one group or transmitting the traffic destined for the Ethernet address of Eth. 1 in step 1255 to the UE 1202.

In step 1265, the UPF 1204 may transmit the traffic received from the App1S 1210 to the UE 1202 in step 1255 using the forwarding path identified in step 1260.

In step 1270, the UE 1202 may identify the forwarding path to transmit the traffic received from the UPF 1204 to the App1C 1201 having the Eth. 1 as the address.

In step 1275, the UE 1202 may transmit the traffic received from the UPF 1204 to the App1C 1201 having the Eth.1 address along the forwarding path identified in step 1270.

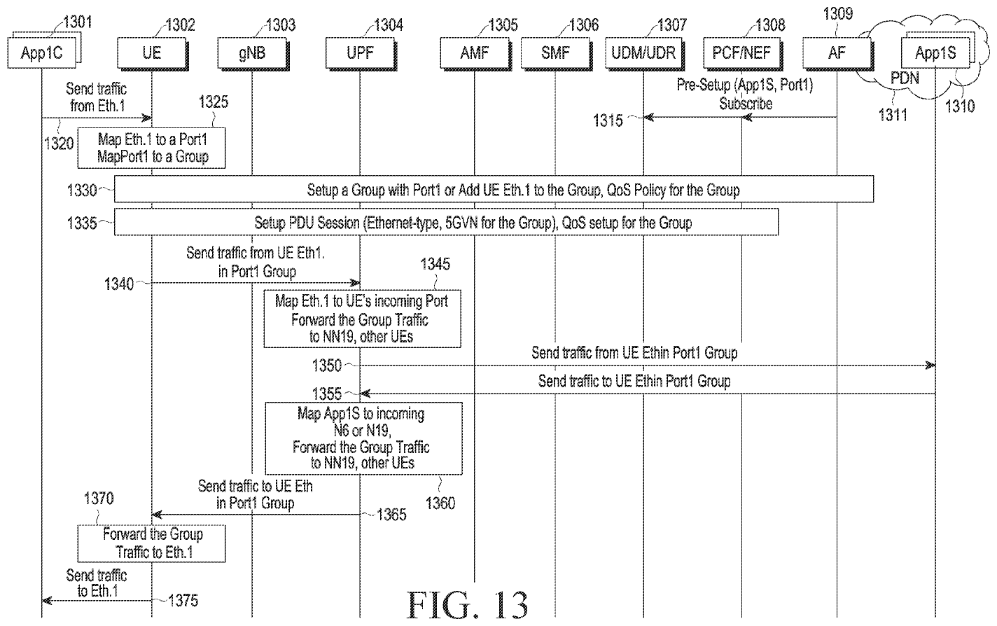

FIG. 13 is a view illustrating a method for performing preset QoS/group mapping based on a port number mapped to an Ethernet address according to an embodiment of the disclosure.

Referring to FIG. 13, in step 1315, the AF 1309 may previously create a group mapped to port 1 for traffic destined for App1S 1310 in the PCF/NEF 1308 and UDM/UDR 1307, and complete subscription for requesting the PCF/NEF 1308 and UDM/UDR 1307 to notify of an event (change or delete) related to the group mapped to port 1. In this case, the AF 1309 or PCF/NEF 1308 may simply request to notify of reception of a request related to the group mapped to port 1 rather than previously creating the group mapped to port 1.

In step 1320, the App1C 1301 having the Ethernet address of Eth.1 may transmit traffic destined for the App1S 1310 to the UE 1302. In this case, the App1C 1301 may be previously configured to have Eth.1 as the Ethernet address. Further, the UE 1302 may map the traffic having Eth.1 to port 1.

In step 1325, the UE 1302 may map port 1 to at least one preset group.

In step 1330, when the at least one group is not created in step 1325, the UE 1302 may create the at least one group, may add the GPSI of the UE 1302 to the at least one group as a member, and may set a QoS policy required for the at least one group. Since step 1330 is similar to steps 830a to 830j of FIG. 8, but the DNN is previously set as the group mapped to port 1, the group mapped to port 1 may be used, as it is, as the DNN without DNN mapping.

In step 1335, the UE 1302 may perform a PDU session setup procedure using the group mapped to port 1 as a DNN to create a PDU session of which the PDU session type is Ethernet, and may set the QoS for the at least one group with the QoS allocated to the group mapped to port 1.

In step 1340, the UE 1302 may transmit the traffic received in step 1315 to the UPF 1304 via the base station 1303 using the PDU session created in step 1335.

In step 1345, the UPF 1304 may map Eth.1 to the incoming port of the UE 1302 to prepare for future forwarding, and may identify the forwarding path to the PDN 1311 in which the App1S 1310 is positioned by directly transferring the received traffic to the N6 interface or by transferring the received traffic to the N6 interface via the N19 interface.

In step 1350, the UPF 1305 may transfer the traffic to the App1S 1310 using the path identified in step 1345.

In step 1355, the App1S 1310 may transmit traffic destined for the at least one group or the Ethernet address of Eth.1 to the UPF 1304.

In step 1360, the UPF 1304 may identify the forwarding path as transmitting the traffic destined for the at least one group in step 1355 to all UEs of the at least one group or transmitting the traffic destined for the Ethernet address of Eth.1 in step 1355 to the UE 1302.

In step 1365, the UPF 1304 may transmit the traffic received from the App1S 1310 to the UE 1302 in step 1355 using the forwarding path identified in step 1360.

In step 1370, the UE 1302 may identify the forwarding path to transmit the traffic received from the UPF 1304 to the App1C 1301 having the Eth.1 as the address.

In step 1375, the UE 1302 may transmit the traffic received from the UPF 1304 to the App1C 1301 having the Eth.1 address along the forwarding path identified in step 1370.

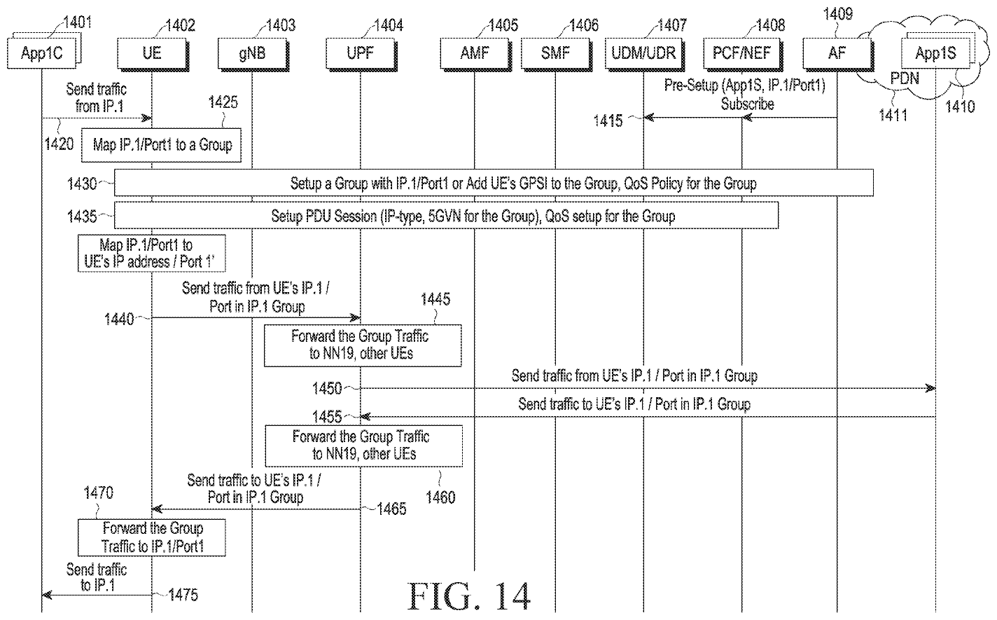

FIG. 14 is a view illustrating a method for performing preset QoS/group mapping based on an IP address according to an embodiment of the disclosure.

Referring to FIG. 14, in step 1415, the AF 1409 may previously create a group mapped to IP.1/port 1 for traffic destined for App1S 1410 in the PCF/NEF 1408 and UDM/UDR 1407, and complete subscription for requesting the PCF/NEF 1409 and UDM/UDR 1407 to notify of an event (change or delete) related to the group mapped to IP.1/port 1. In this case, the AF 1409 or PCF/NEF 1409 may simply request to notify of reception of a request related to the group mapped to port 1 rather than previously creating the group mapped to IP.1/port 1.

In step 1420, the App1C 1401 having the IP address of IP.1 may transmit traffic destined for the App1S 1410 to the UE 1402. In this case, it may be previously configured that the traffic is transmitted from the App1C 1401 having the IP.1 address and port 1.

In step 1425, the UE 1402 may map IP.1/Port 1 to at least one preset group.

In step 1430, when the at least one group is not created in step 1425, the UE 1402 may create the at least one group, may add the GPSI of the UE 1402 to the at least one group as a member, and may set a QoS policy required for the at least one group. Since step 1430 is similar to steps 1130a to 1130j of FIG. 11, but the DNN is previously set as the group mapped to IP.1/port 1, the group mapped to IP.1/port 1 may be used, as it is, as the DNN without DNN mapping.

In step 1435, the UE 1402 may perform a PDU session setup procedure using the group mapped to IP.1/port 1 as a DNN to create a PDU session of which the PDU session type is IP, and may set the QoS for the at least one group with the QoS allocated to the group mapped to IP.1/port 1. Since step 1435 is similar to steps 1140a to 1140c of FIG. 11, but the DNN is previously set as the group mapped to IP.1/port 1, the policy for routing and QoS configuration previously set may be used as it is. Further, the UE 1402 may map IP.1/port. 1 to the IP address of the UE 1402 and port 1′, which is the port of the UE 1402.

In step 1440, the UE 1402 may transmit the traffic received in step 1415 to the UPF 1404 via the base station 1403 using the PDU session created in step 1435.

In step 1445, the UPF 1404 may identify the forwarding path to the PDN 1411 in which the App1S 1410 is positioned by directly transferring the traffic received from the UE 1402 to the N6 interface or by transferring the received traffic to the N6 interface via the N19 interface.

In step 1450, the UPF 1404 may transfer the traffic to the App1S 1410 using the forwarding path identified in step 1445.

In step 1455, the App1S 1410 may transmit traffic destined for the at least one group or the IP address and port 1′ of the UE 1402 to the UPF 1404.

In step 1460, the UPF 1404 may identify the forwarding path as transmitting the traffic destined for the at least one group to all UEs of the at least one group or transmitting the traffic destined for the IP address of the UE 1402 to the UE 1402.

In step 1465, the UPF 1404 may transmit the traffic received from the App1S 1410 to the UE 1402 in step 1455 using the forwarding path identified in step 1460.

In step 1470, the UE 1402 may identify the forwarding path to transmit the traffic destined for the IP address and port 1′ of the UE 1402, received from the UPF 1404 in step 1465 to port 1 of the App1C 1401 having the IP.1 address. In this case, the UE 1402 may use the information mapped in step 1435.

In step 1475, the UE 1402 may transmit the traffic destined for the IP address and port 1′ of the UE 1402, received from the UPF 1404 in step 1465 to port 1 of the App1C 1401 having the IP.1 address using the forwarding path identified in step 1470.

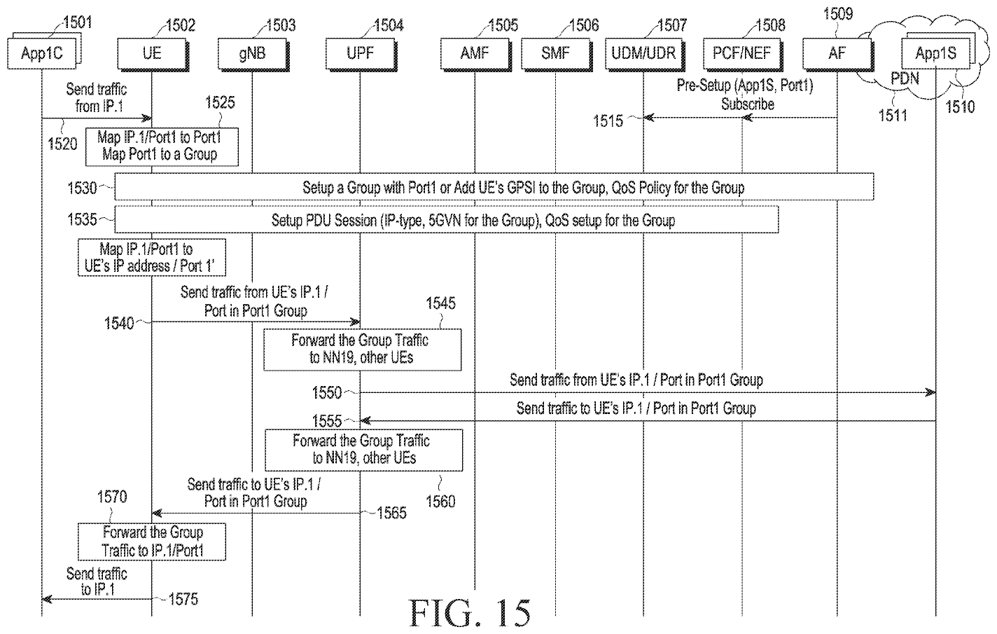

FIG. 15 is a view illustrating a method for performing preset QoS/group mapping based on a port number mapped to an IP address according to an embodiment of the disclosure.

Referring to FIG. 15, in step 1515, the AF 1509 may previously create a group mapped to port 1 for traffic destined for App1S 1510 in the PCF/NEF 1508 and UDM/UDR 1507, and complete subscription for requesting the PCF/NEF 1508 and UDM/UDR 1507 to notify of an event (change or delete) related to the group mapped to port 1. In this case, the AF 1509 or PCF/NEF 1508 may simply request to notify of reception of a request related to the group mapped to port 1 rather than previously creating the group mapped to port 1.

In step 1520, the App1C 1501 having the IP address of IP.1 may transmit traffic destined for the App1S 1510 to the UE 1502. In this case, it may be previously configured that the traffic destined for the App1S 1510 is transmitted from the App1C 1501 having the IP.1 address and port 1. In step 1525, the UE 1502 may map IP.1/Port 1 to at least one preset group.

In step 1530, when the at least one group is not created in step 1525, the UE 1502 may create the at least one group, may add the GPSI of the UE 1502 to the at least one group as a member, and may set a QoS policy required for the at least one group. Since step 1530 is similar to steps 1130a to 1130j of FIG. 11, but the DNN is previously set as the group mapped to port 1, the group mapped to port 1 may be used, as it is, as the DNN without DNN mapping.

In step 1535, the UE 1402 may perform a PDU session setup procedure using the group mapped to port 1 as a DNN to create a PDU session of which the PDU session type is IP, and may set the QoS for the at least one group with the QoS allocated to the group mapped to port 1. Since step 1535 is similar to steps 1140a to 1140c of FIG. 11, but the DNN is previously set as the group mapped to port 1, the policy for routing and QoS configuration previously set may be used as it is. Further, the UE 1502 may map IP.1/port 1 to the IP address of the UE 1502 and port 1′, which is the port of the UE 1502.

In step 1540, the UE 1502 may transmit the traffic received in step 1515 to the UPF 1504 via the base station 1503 using the PDU session created in step 1535.

In step 1545, the UPF 1504 may identify the forwarding path to the PDN 1511 in which the App1S 1510 is positioned by directly transferring the traffic received from the UE 1502 to the N6 interface or by transferring the received traffic to the N6 interface via the N19 interface.

In step 1550, the UPF 1504 may transfer the traffic to the App1S 1510 using the forwarding path identified in step 1545.

In step 1555, the App1S 1510 may transmit traffic destined for the at least one group or the IP address and port 1′ of the UE 1502 to the UPF 1504.

In step 1560, the UPF 1504 may identify the forwarding path as transmitting the traffic destined for the at least one group to all UEs of the at least one group or transmitting the traffic destined for the IP address of the UE 1502 to the UE 1502.

In step 1565, the UPF 1505 may transmit the traffic received from the App1S 1510 to the UE 1502 in step 1555 using the forwarding path identified in step 1560.

In step 1570, the UE 1502 may identify the forwarding path to transmit the traffic destined for the IP address and port 1′ of the UE 1502, received from the UPF 1504 in step 1565 to port 1 of the App1C 1501 having the IP.1 address. In this case, the UE 1502 may use the information mapped in step 1535.

In step 1575, the UE 1502 may transmit the traffic destined for the IP address and port 1′ of the UE 1502, received from the UPF 1504 in step 1565 to port 1 of the App1C 1501 having the IP.1 address using the forwarding path identified in step 1570.

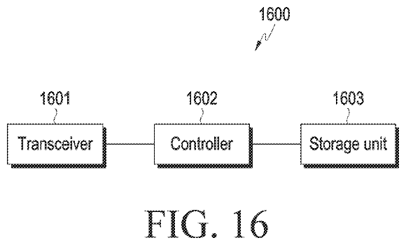

FIG. 16 is a view illustrating a structure of a network entity (ies) according to an embodiment of the disclosure. The network entity according to the embodiment of FIG. 16 may include the network entities included in FIG. 5.

Referring to FIG. 16, a network entity 1600 may include a transceiver 1601, a controller 1602, and a storage unit 1603. The controller 1602 may be defined as a circuit or application-specific integrated circuit or at least one processor.

The transceiver 1601 may transmit and receive signals to/from other network entities. For example, the transceiver 1601 may receive traffic from App1C which has an address of Eth. 1 to App1S or transmit traffic from App1S to App1C which has the address of Eth. 1.

The controller 1602 may control the overall operation of the network entity according to an embodiment. For example, the controller 1602 may perform control to perform operations according to the procedure described above in connection with FIGS. 6 to 15B. For example, the controller 1602 may control an operation for performing a procedure for setting up an Ethernet-type PDU session or an IP-type PDU session according to the above-described embodiments.

The storage unit 1603 may store at least one of information transmitted/received via the transceiver 1601 and information generated via the controller 1602.

The methods according to the embodiments descried in the specification or claims of the disclosure may be implemented in hardware, software, or a combination of hardware and software.

When implemented in software, there may be provided a computer readable storage medium storing one or more programs (software modules). One or more programs stored in the computer readable storage medium are configured to be executed by one or more processors in an electronic device. One or more programs include instructions that enable the electronic device to execute methods according to the embodiments described in the specification or claims of the disclosure.

The programs (software modules or software) may be stored in random access memories, non-volatile memories including flash memories, read-only memories (ROMs), electrically erasable programmable read-only memories (EEPROMs), magnetic disc storage devices, compact-disc ROMs, digital versatile discs (DVDs), or other types of optical storage devices, or magnetic cassettes. Or, the programs may be stored in a memory constituted of a combination of all or some thereof. As each constituting memory, multiple ones may be included.

The programs may be stored in attachable storage devices that may be accessed via a communication network, such as the Internet, Intranet, local area network (LAN), wide area network (WLAN), or storage area network (SAN) or a communication network configured of a combination thereof. The storage device may connect to the device that performs embodiments of the disclosure via an external port. A separate storage device over the communication network may be connected to the device that performs embodiments of the disclosure.

In the above-described specific embodiments, the components included in the disclosure are represented in singular or plural forms depending on specific embodiments proposed. However, the singular or plural forms are selected to be adequate for contexts suggested for ease of description, and the present invention is not limited to singular or plural components. As used herein, the singular forms “a,” “an,” and “the” are intended to include the plural forms as well, unless the context clearly indicates otherwise.

Although specific embodiments of the present invention have been described above, various changes may be made thereto without departing from the scope of the present invention. Thus, the scope of the disclosure should not be limited to the above-described embodiments, and should rather be defined by the following claims and equivalents thereof.

1. A method by a user equipment (UE) supporting a plurality of group communications having different qualities of service (QoSs) in a wireless communication system, the method comprising:
receiving, from at least one application client having a predetermined address value, traffic for an application server;
setting a first group associated with the predetermined address value;
establishing a PDU session for one of the first group associated with the predetermined address value and a second group associated with the application server set by an application function (AF); and
transmitting the traffic to the application server through the generated PDU session.

2. The method of claim 1, further comprising adding a GPSI of the UE, as a member, to the first group.

3. The method of claim 1, further comprising mapping the predetermined address value to the first group.

4. The method of claim 1, further comprising mapping the predetermined address value to an Internet protocol (IP) address of the UE after establishing the PDU session.

5. The method of claim 1, wherein the predetermined address value is an Ethernet address or an IP address.

6. A UE supporting a plurality of group communications having different qualities of service (QoSs) in a wireless communication system, comprising:
a transceiver; and
a controller configured to control the transceiver to receive from, at least one application client having a predetermined address value, traffic for an application server, set a first group associated with the predetermined address value, establish a PDU session for one of the first group associated with the predetermined address value and a second group associated with the application server set by an application function (AF), and control the transceiver to transmit the traffic to the application server through the generated PDU session.

7. The UE of claim 6, wherein the controller is further configured to add a GPSI of the UE, as a member, to the first group.

8. The UE of claim 6, wherein the controller is further configured to map the predetermined address value to the first group.

9. The UE of claim 6, wherein the controller is further configured to map the predetermined address value to an Internet protocol (IP) address of the UE after establishing the PDU session.

10. The UE of claim 6, wherein the predetermined address value is an Ethernet address or an IP address.
